(19) United States
(12) Patent Application Publication
(10) Pub. No.: US 2022/0146839 A1
(43) Pub. Date: May 12, 2022

(54) BINOCULAR TYPE HEAD MOUNTED DISPLAY SYSTEM WITH ADJUSTABLE INTERPUPILLARY DISTANCE MECHANISM

(71) Applicant: Lumus Ltd., Ness Ziona (IL)

(72) Inventor: Michael MILLER, Tel Aviv (IL)

(21) Appl. No.: 17/436,600

(22) PCT Filed: Jun. 3, 2020
(86) PCT No.: PCT/IL2020/050621

§ 371 Date: Sep. 5, 2021

Related U.S. Application Data
(60) Provisional application No. 62/856,759, filed on Jun. 4, 2019.

(51) Int. Cl. G02B 27/01; G02B 7/12

(52) U.S. Cl. CPC G02B 27/0176; G02B 7/12; G02B 2027/0154; G02B 2027/0134; G02B 27/0172

(57) ABSTRACT

A head-mounted display apparatus configured to be worn by a viewer. The apparatus includes a pair of display modules moveably coupled to a curved rail, the display modules configured to project stereoscopic images toward the viewer, wherein a first one of the display modules projects a first stereoscopic image and a second one of the display modules projects a second stereoscopic image, the first and second stereoscopic images creating a single unified virtual stereo image that converges at a predetermined convergence distance in front of the viewer. The apparatus further includes an adjustment mechanism configured to move each of the display modules along the curved rail symmetrically about a midpoint of the rail, thereby varying a distance between the display modules while maintaining the predetermined convergence distance.

### TECHNICAL FIELD

The presently disclosed subject matter relates to head-mounted displays, and, more particularly, to binocular type head-mounted displays.

### BACKGROUND

Binocular type head-mounted displays (HMD) for augmented reality (AR) applications display virtual images, which are presented on top of the real-world environment of the user. The virtual images are displayed in stereo using two display modules mounted within the binoculars, each display module independently displaying a stereoscopic image to a pupil so that the wearer of the HMD sees a single unified virtual image having a perceived depth. In order to correctly imitate human stereo vision of the real world, the two stereoscopic images, and hence the display modules, have to be aligned correctly in order to achieve the desired image. Thus, for proper depth perception, the display modules and/or the images exiting therefrom should be oriented so that each image hits the respective pupil at a precise angle such that the viewer sees a unified virtual stereo image located in space at a predefined distance in front of the wearer.

Typically, minimal HMD systems include a factory-level initial calibration suitable for most wearers and most applications. Additionally, some robust HMD systems include a series of sensors (e.g. cameras, inertial measurement unit (IMU), eye tracking sensors, etc.) and a computational unit configured to automatically calibrate the display modules on demand, with or without user's involvement. “Calibration” in this context refers to setting the angle between the stereo images to achieve the optimal convergence distance for the particular application, as described above.

Besides calibration, proper HMD design must also consider variance in interpupillary distance (IPD) between users, which typically varies between 55-74 mm for adults, but can be as small as 40 mm for children. Variance in IPD is typically accounted for using one of two methods. The first method involves designing display modules which transmit images across a wide horizontal eye-motion-box. However this method increases the complexity of the optical modules, as well as their dimensions, and reduces light efficiency and brightness.

Another option to achieve compatibility with various IPDs is to provide a mechanical mechanism for adjusting the distance between display modules, either manually or automatically (e.g. using one or more sensors and a computational unit). According to this latter method, the optical module design requirements can be simplified, light efficiency improved and module dimensions reduced.

The mechanical mechanism described above must be interoperable with the calibration system used by the particular HMD, meaning that varying the distance between display modules will not adversely affect the convergence distance of the images. In view of the two types of HMD systems described earlier, the robust HMD can simply recalibrate itself after adjusting the distance between the displays to the user's IPD. However, in the minimal HMD system, the movement mechanism has to maintain the factory calibration conditions including the convergence distance. Thus, once the distance between the modules is adjusted for IPD, the relative angle between stereo images would need to be adjusted as well in order to maintain the convergence distance.

### GENERAL DESCRIPTION

The present invention provides a system and method for automatic adjustment of the stereo image convergence angle as the distance between display modules changes. The angle adjustment is achieved by using a curved rail on which the display modules move. The curvature of the rail should be designed according to required convergence distance that is defined for the system, and that will be used during the factory calibration of the system.

Thus, according to one aspect of the presently disclosed subject matter there is provided a head-mounted display apparatus configured to be worn by a viewer including: a pair of display modules moveably coupled to a curved rail, the display modules configured to project stereoscopic images toward the viewer, wherein a first one of the display modules projects a first stereoscopic image and a second one of the display modules projects a second stereoscopic image, the first and second stereoscopic images creating a single unified virtual stereo image that converges at a predetermined convergence distance in front of the viewer; and an adjustment mechanism configured to move each of the display modules along the curved rail symmetrically about a midpoint of the rail, thereby varying a distance between the display modules while maintaining the predetermined convergence distance.

In some embodiments, the apparatus includes a frame supporting the curved rail and the adjustment mechanism.

In some embodiments, the adjustment mechanism is configured to vary the distance between the display modules between 40 mm-80 mm.

In some embodiments, the predetermined convergence distance is in the range of 0.2 meters to infinity.

In some embodiments, the display modules are coupled to the curved rail at an angular orientation that provides a virtual stereo image that converges at the predetermined convergence distance.

In some embodiments, the curved rail has a curvature that facilitates the pair of display modules providing a virtual stereo image that converges at the predetermined convergence distance.

In some embodiments, the convergence distance is approximately equal to the radius of a circle defined by an arc of the curved rail.

In some embodiments, each of the display modules includes a compact projector module coupled to a combiner module.

In some embodiments, the combiner module includes a light-guide optical element made of a transparent substrate and having a pair of parallel external surfaces and a plurality of mutually parallel partially reflective internal surfaces angled obliquely relative to the pair of external surfaces.

In some embodiments, the apparatus includes head mounting gear.

### BRIEF DESCRIPTION OF THE DRAWINGS

In order to understand the invention and to see how it can be carried out in practice, embodiments will be described, by way of non-limiting examples, with reference to the accompanying drawings, in which:

FIGS. 1A-1B illustrate schematically of a top-down view of an HMD according to embodiments of the presently disclosed subject matter;

FIG. 2 illustrates schematically an inside perspective view of an HMD according to embodiments of the presently disclosed subject matter;

FIG. 3A illustrates schematically a frontal perspective view of an exemplary display module according to embodiments of the presently disclosed subject matter; and

FIG. 3B illustrates schematically a side view of an exemplary display module according to embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, and components have not been described in detail so as not to obscure the presently disclosed subject matter. Throughout this description, the terms “head-mounted display” and “HMD” should be understood to refer to a binocular type HMD, and the terms “user”, “wearer” and “viewer” all refer to the person viewing the image projected by the HMD.

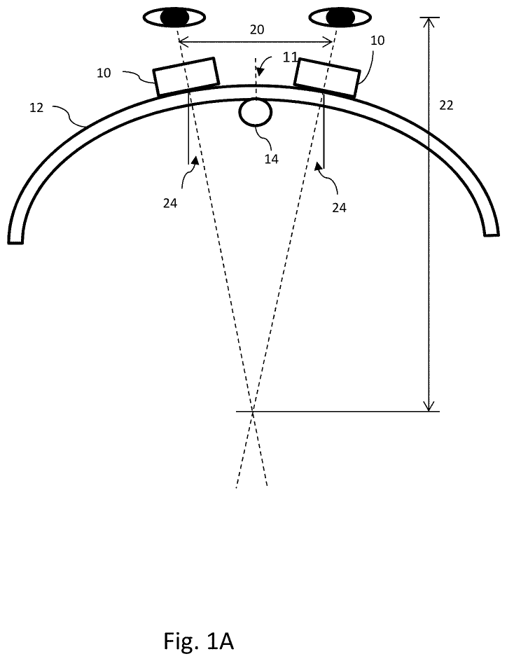

FIGS. 1A-1B illustrate schematically a top-down view of a binocular type HMD according to embodiments of the disclosed subject matter. The HMD includes a pair of display modules 10 moveably coupled to an outwardly (relative to the HMD wearer) arcing curved rail 12, such that each display module is approximately equidistant from the midpoint 11 of the rail. A first one of the display modules projects a first stereoscopic image toward a first eye of the HMD wearer, while the second one of the display modules projects a second stereoscopic image toward the other eye of the HMD wearer. For example, the display module on the left side of the curved rail projects an image to the wearer's left eye, while the display module on the right side projects an image to the wearer's right eye.

During system assembly, the HMD is calibrated so that the display modules are mounted on the rail at an angle that combines the projected stereo images to a single unified virtual image at the predetermined convergence distance 22. The exact mounting angle of the display modules relative to the curved rail depends on the specific optical design parameters (e.g. line of sight) of the display modules in use. Once the assembly is verified for one IPD, adjustment of the display modules for any other IPD will keep the convergence distance constant.

Angle 24 in FIGS. 1A-1B is referred to herein as the “convergence angle” necessary to achieve the desired convergence distance. As stated above, convergence angle 24 is typically set during calibration (i.e. prior to first use and typically before reaching the consumer) and can be manipulated by rotating the image projection axis relative to the pupil. After setting the convergence angle, when viewed by the user the two stereoscopic images combine to create a single unified virtual stereo image that appears to be located in space at convergence distance 22 in front of the viewer. In some embodiments, such as in AR applications, the display modules may additionally facilitate direct viewing of the outside world in front of the viewer, such that the projected virtual image having a perceived depth and the real-world “image” combine to create the AR effect. In other instances, the view of the outside world may be obstructed in order to create more of a virtual reality effect in which the virtual stereo image is the only image seen by the viewer.

In order to vary the distance 20 between the display modules to accommodate variability in viewer IPD, the HMD further includes an adjustment mechanism 14 configured to simultaneously move both display modules along the curved rail in opposite directions and symmetrically about the midpoint of the rail, thereby increasing or decreasing the distance 20 between the display modules. Due to the curvature of the rail, an increase in the distance between the display modules (i.e. from 20 to 20′) results in a corresponding increase in convergence angle (i.e. 24 to 24′), thereby maintaining the predetermined convergence distance 22. Likewise, decreasing the distance between display modules results in a corresponding decrease in the convergence angle 24, again approximately maintaining the predetermined convergence distance 22. Adjustment mechanisms for moving objects symmetrically in opposite directions along a rail or track are known to persons skilled in the art and need not be elaborated on herein.

By way of non-limiting example, FIG. 1A illustrates a schematic view of the HMD with display modules 10 separated by a distance 20 of 55 m, corresponding to the low end of the range of IPDs. In this case, due to the preconfigured curvature of the curved rail 12, when distance 20 is 55 mm, the convergence angle 24 is approximately 0.79 degrees which is precisely the convergence angle required to provide a convergence distance 22 of 2 m.

FIG. 1B illustrates the same HMD now adjusted for an IPD of 74 mm. In this case, when distance 20′ is 74 mm, convergence angle 24′ is approximately 1.06 degrees, which is once again the precise angle required to provide a convergence distance 22 of 2 m.

It should be understood that the above examples are non-limiting, and in fact the HMD can be designed to support any required convergence distance in the range of 0.2 m-∞ by determining the precise curvature required to provide the needed convergence angle across the range of IPDs. The desired curvature can be set for any convergence distance by considering the curved rail as an arc of a circle, with the circle radius defined by the convergence distance 22.

Additionally, while the above examples provide for IPDs in the range of 54 mm-79 mm, it should be understood that the same principles can be applied to support a much larger range of IPDs, including without limitation 40 mm-80 mm.

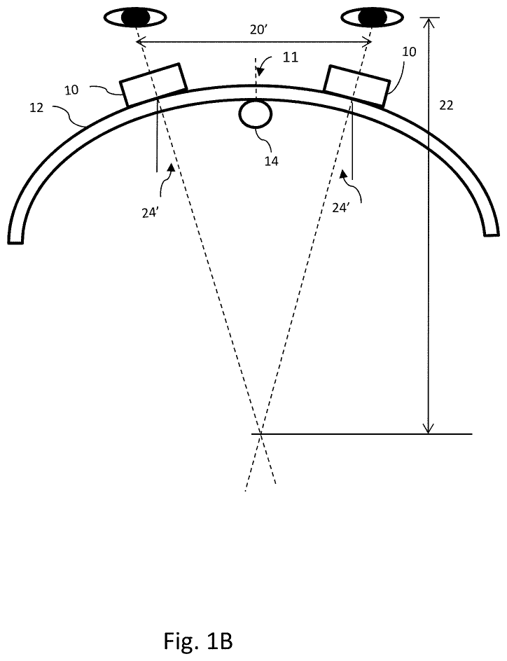

FIG. 2 illustrates schematically an inside perspective view of the HMD according to embodiments disclosed herein, including an optional frame 26 to support and/or house curved rail 12 and adjustment mechanism 14. In some embodiments (not shown), the HMD may further include head mounting gear for holding the HMD in place on a wearer's head. Head mounting gear may include, without limitation, straps, glasses and/or a helmet.

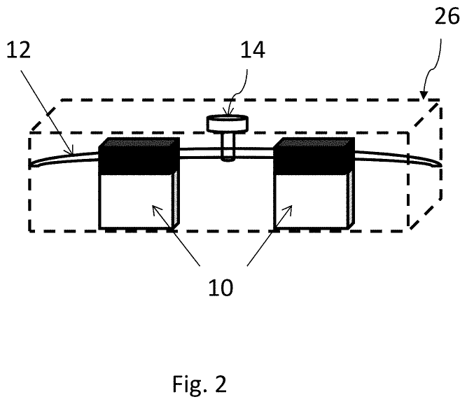

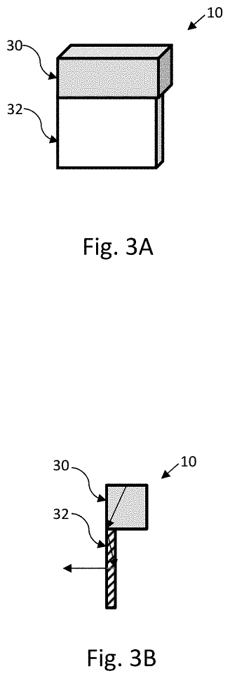

FIGS. 3A-3B show a perspective and side view, respectively, of an exemplary display module 10 according to some embodiments. Display module 10 may include, e.g. a compact image projector module 30 and a combiner module 32. Projector module 30 is configured to inject a stereoscopic image into the combiner module 32. Combiner module 32 is configured to receive an injected image, combine the projected image with a real-world image, and couple-out the combined image to the viewer. In some examples, combiner 32 may be implemented using a light-guide optical element (or “waveguide”) consisting of a transparent substrate having a pair of parallel external surfaces and a plurality of mutually parallel partially reflective internal surfaces (“facets”) 34 that are angled obliquely relative to the pair of external surfaces and configured to couple out the combined image to the viewer. The stereoscopic image injected into the waveguide propagates through waveguide via total internal reflection and is coupled out to the viewer via the facets. The real-world image is transmitted directly to the viewer via the transparency of the combiner substrate. Display modules such as that provided above are known to persons skilled in the art and need not be elaborated herein.

It should be appreciated that the curved rail shown in the drawings is shown with an exaggerated curvature for clarity of description, and that in practice the curved rail will have a much gentler curve. It should further be appreciated that the curved rail need not be arcuate in shape along its entire length, but rather only along the portion that the display modules are configured to move along, which will typically though not necessarily correspond to the maximum IPD the HMD is designed to accommodate.

1. A head-mounted display apparatus configured to be worn by a viewer comprising:
a pair of display modules moveably coupled to a curved rail, the display modules configured to project stereoscopic images toward the viewer, wherein a first one of the display modules projects a first stereoscopic image and a second one of the display modules projects a second stereoscopic image, the first and second stereoscopic images creating a single unified virtual stereo image that converges at a predetermined convergence distance in front of the viewer; and
an adjustment mechanism configured to move each of the display modules along the curved rail symmetrically about a midpoint of the rail, thereby varying a distance between the display modules while maintaining the predetermined convergence distance.

2. The apparatus of claim 1, further comprising a frame supporting the curved rail and the adjustment mechanism.

3. The apparatus of claim 1, wherein the adjustment mechanism is configured to vary the distance between the display modules between 40 mm-80 mm.

4. The apparatus of claim 1, wherein the predetermined convergence distance is in the range of 0.2 meters to infinity.

5. The apparatus of claim 1, wherein the display modules are coupled to the curved rail at an angular orientation that provides a virtual stereo image that converges at the predetermined convergence distance.

6. The apparatus of claim 1, wherein the curved rail has a curvature that facilitates the pair of display modules providing a virtual stereo image that converges at the predetermined convergence distance.

7. The apparatus of claim 1, wherein the convergence distance is approximately equal to the radius of a circle defined by an arc of the curved rail.

8. The apparatus of claim 1, wherein each of the display modules comprises a compact projector module coupled to a combiner module.

9. The apparatus of claim 7, wherein the combiner module comprises a light-guide optical element made of a transparent substrate and having a pair of parallel external surfaces and a plurality of mutually parallel partially reflective internal surfaces angled obliquely relative to the pair of external surfaces.

10. The apparatus of claim 1, further including head mounting gear.
